(19) United States
(12) Patent Application Publication
(10) Pub. No.: US 2007/0162622 A1
(43) Pub. Date: Jul. 12, 2007

(54) Dual flash disk storage device

(76) Inventor: Jiunn-Chung Lee, Taipei (TW)

Correspondence Address: HDSL, 4331 STEVENS BATTLE LANE, FAIRFAX, VA, 22033, US

(21) Appl. No.: 11/530,139

(22) Filed: Sep. 8, 2006

(30) Foreign Application Priority Data
Nov. 25, 2005 (TW) 094143545

(51) Int. Cl. G06F 3/00

(52) U.S. Cl. 710/2

(57) ABSTRACT

A dual flash disk storage device integrates a first flash disk storage device and a second flash disk storage device into a single module by an advanced technology attachment (ATA) interface, and has two independent physical first and second flash disk storage devices, and uses a jumper to set the first flash disk storage device to a master or a second flash disk storage device to a slave. After the master and slave are set up, a computer system can distinguish the two independent physical hard disks, so that users can store or read data in the first flash disk storage device or the second flash disk storage device.

### BACKGROUND OF THE INVENTION

1. Field of the Invention

The present invention relates to a flash disk storage device, and more particularly to a flash disk storage device having two physical hard disks in a single module.

2. Description of Prior Art

In recent years, flash disk storage devices are used extensively in many small systems or embedded systems, and thus flash disk storage devices gradually replace floppy and hard disks and become a new-generation embedded storage medium. Since a flash disk storage device has the same functions as a hard disk drive and the features of a small volume, a low power consumption, a high shock resistance and free of noises, therefore flash disk storage devices can be applied in many small systems such as Thin Client, Set Top Box, and POS.

The motherboard of these small systems or embedded systems has two Advanced Technology Attachment (ATA) interface channels, and every channel can be connected to two flash disk storage devices in series to increase the storage capacity, and a jumper can be used to set a flash disk storage device to a master (Device0) or a slave (Device1), so that users can execute an operation of reading or storing data in a master or a slave according to the setup. Therefore, an ATA interface storage device can be connected to four flash disk storage devices in series, but if a same channel has to be connected to two flash disk storage devices in series to increase the storage capacity, users must use a 40-pin flat cable for the connection. Such arrangement not only increases the number of flat cables and costs, but also causes difficulties to the expansion of a light, thin, short and compact small system or embedded system, because the flat cable and two flash disk storage device modules will occupy the internal space of the system. As a result, it is a difficult technique to connect two or more flash disk storage device modules in a very limited internal space of the small system or embedded system.

### SUMMARY OF THE INVENTION

In view of the foregoing shortcomings of the prior art, the inventor of the present invention based on years of experience in the related industry to conduct experiments and modifications, and finally designed a dual flash disk storage device in accordance with the present invention.

Therefore, the present invention is to overcome the foregoing shortcomings and avoid existing deficiencies by integrating two flash disk storage devices into a single module by an Advanced Technology Attachment (ATA) interface as a basic architecture, and such module has two independent storage devices to save the flat cables and lower the costs, so that the flat cable no longer occupies the internal space of the system to further reduce the volume of a small system.

The dual flash disk storage device of the invention primarily integrates a first flash disk storage device and a second flash disk storage device on a same circuit board to form a single module having two independent flash disk storage devices, and an IDE interface is connected to the computer motherboard, and a jumper on the circuit board is used for setting the first flash disk storage device to a master or a second flash disk storage device to a slave. After the master and slave are set, the two independent physical hard disks can be distinguished during a computer operation, so that users can store or read data in the first flash disk storage device or the second flash disk storage device.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic circuit block diagram of a dual flash disk storage device in accordance with the present invention;

FIG. 2 is a schematic view of a front side of a circuit board of a dual flash disk storage device in accordance with the present invention; and

FIG. 3 is a schematic view of a back side of a circuit board of a dual flash disk storage device in accordance with the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

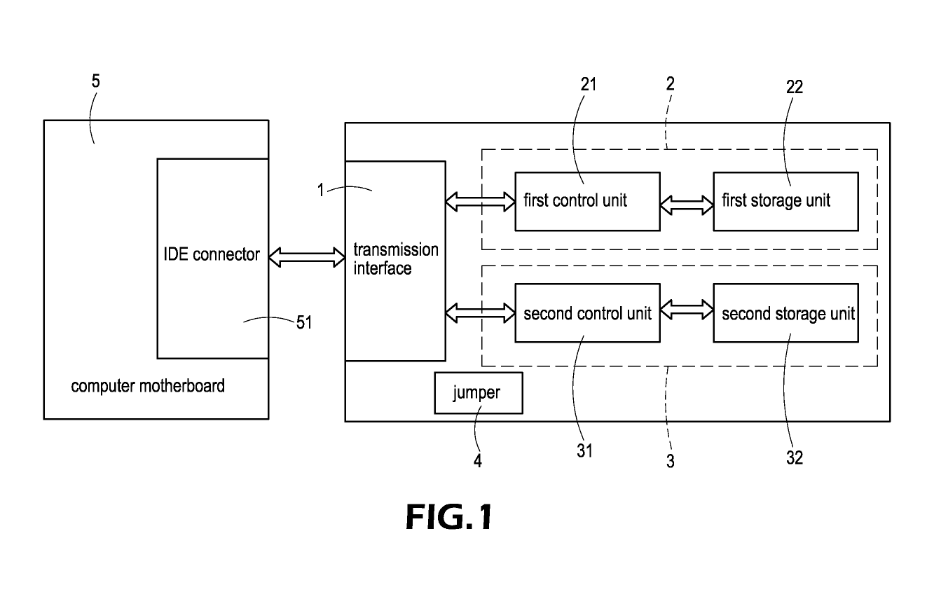

Referring to FIG. 1 for a schematic circuit block diagram of a dual flash disk storage device in accordance with the present invention, the dual flash disk storage device comprises: a transmission interface 1, a first flash disk device (MASTER) 2 electrically coupled to the transmission interface 1, and a second flash disk device (SLAVE) 3 electrically coupled to the transmission interface 1, and an Advanced Technology Attachment (ATA) interface of the flash disk storage device is used as a basic architecture to integrate two independent physical flash disk storage devices into a single module, so as to save the flat cables and lower the costs, and also save the internal space of the system occupied by the flat cables.

The foregoing transmission interface 1 is an Integrated Drive Electronics (IDE) interface, and such IDE interface is an interface that uses 8 bits or 16 bits or more to control a flash disk storage device and is inserted into an IDE interface connector 51 of a computer motherboard 5 to provide data signal transmissions between the computer motherboard 4 and the IDE interface, so as to facilitate the control of reading or storing data in the first and second flash disk devices 2, 3.

The first flash disk device 2 is comprised of a first control unit 21 and at least one first storage unit 22, and the first control unit 21 is electrically coupled to the transmission interface 1 and the first storage unit 22. The first control unit 21 receives signals transmitted from the transmission interface 1, and the process of reading or storing data in the first storage unit 22 can be controlled after the signals are processed by the first control unit 21. The first storage unit 22 comprises a flash memory for storing data in the first storage unit 22 by the control of the first control unit 21.

The second flash disk device 3, substantially the same as the first flash disk device 2, is comprised of a second control unit 31 and at least one second storage unit 32. The second control unit 31 is electrically coupled to the transmission interface 1 and the second storage unit 32. The second control unit 31 receives signals transmitted from the transmission interface 1, and the process of reading or storing data in the second storage unit 32 can be controlled after the signals are processed by the second control unit 31. Similarly, the second storage unit 32 comprises a flash memory.

The jumper 4 is integrated and electrically coupled with the transmission interface 1, first flash disk device 2 and second flash disk device 3 into a same module. Such jumper can set the first flash disk storage device 2 to a master (Device0) or a second flash disk storage device 3 to a slave (Device1).

If users connect the flash disk storage device to an IDE connector 51 of a computer motherboard 5 and use the jumper 4 to set the first flash disk storage device 2 to a master (Device0) or a second flash disk storage device 3 to a slave (Device1), and then turn on a computer, the computer motherboard 5 will detect two independent physical hard disks on a single module, and the computer will assign two independent physical first and second flash disk storage devices 2, 3 to the operating system, so that users can store data in the first flash disk storage device 2 or the second flash disk storage device 3, or read data stored in the first flash disk storage device 2 or the second flash disk storage device 3.

If one of the first flash disk storage device 2 and the second flash disk storage device 3 is damaged and cannot store data during an application, users can change the setting by the jumper 4 to execute another normal flash disk storage device.

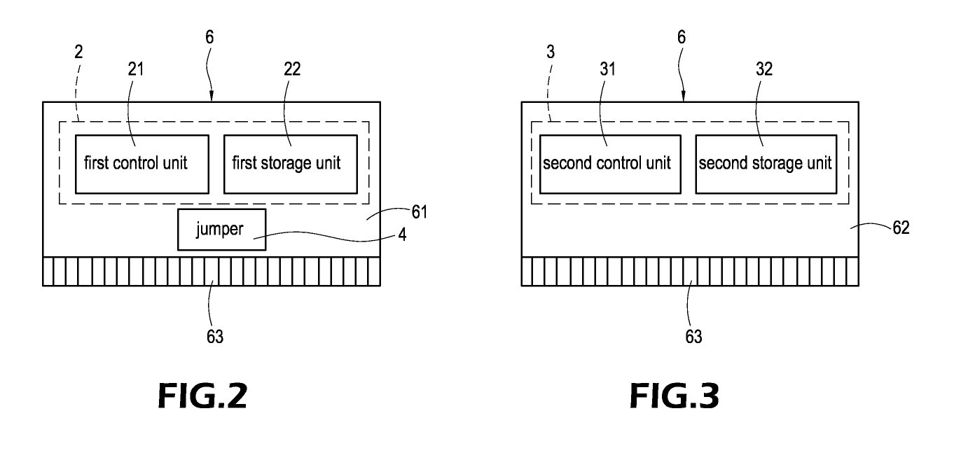

Referring to FIGS. 2 and 3 for the schematic views of a front side and a back side of a circuit board of a dual flash disk storage device front side in accordance with the present invention respectively, the structure of the dual flash disk storage device comprises:

a circuit board 6, having a front side 61, a back side 62, and a connector 63;

a first flash disk storage device 2, soldered onto the front side 61 of the circuit board 6, and comprised of a first control unit 21 and at least one first storage unit 22;

a second flash disk storage device 3 soldered onto the back side 62 of the circuit board 6, and comprised of a first control unit 31 and at least one first storage unit 32;

a jumper 4, electrically coupled to the connector 63, the first flash disk device 2 and the second flash disk device 3;

In an application, users can use the jumper 4 to set the first flash disk storage device 2 to a master or the second flash disk storage device 3 to a slave, after a connector 63 of the circuit board 6 having a dual flash disk storage device is connected to an IDE connector 51 of the computer motherboard 5 (as shown in FIG. 1). When a computer is booted, the computer will detect these flash disk storage devices as two independent physical hard disks and assign two independent physical first and second flash disk storage devices 2, 3 to the operating system for users to store or read data.

After the circuit board 6 of the dual flash disk storage devices is connected to an IDE connector 51 of the computer motherboard 5, we can save the flat cables and lower the costs. As a result, we can further reduce the volume of the small system, since we no longer need the flat cable for connecting two flash disk storage devices in series, which will occupy much internal spaces of the system.

In addition, the first and second flash disk storage devices 2, 3 can be built on the same side of the circuit board 6.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A dual flash disk storage device, connected to an IDE interface connector of a computer motherboard, comprising:
a transmission interface;
a first flash disk storage device, electrically coupled to the transmission interface;
a second flash disk storage device, electrically coupled to the transmission interface,
thereby the transmission interface integrates the first and the second flash disk storage devices to form a dual flash disk storage device.

2. The dual flash disk storage device of claim 1, wherein the transmission interface is an IDE interface.

3. The dual flash disk storage device of claim 1, wherein the first flash disk device includes a first control unit and at least one first storage unit, and the first control unit is electrically coupled to the transmission interface and the first storage unit.

4. The dual flash disk storage device of claim 3, wherein the first storage unit is a flash memory.

5. The dual flash disk storage device of claim 1, wherein the second flash disk device includes a second control unit and at least one second storage unit, and the second control unit is electrically coupled to the transmission interface and the second storage unit.

6. The dual flash disk storage device of claim 5, wherein the second storage unit is a flash memory.

7. The dual flash disk storage device of claim 1, further including a jumper for setting the two flash disk storage devices separately to a master or a slave.

8. A dual flash disk storage device, inserted into an IDE interface connector of a computer motherboard, comprising:
a circuit board, having a connector thereon;
a first flash disk storage device soldered onto the circuit board; and
a second flash disk storage device soldered onto the circuit board,
thereby a connector of the circuit board is coupled to the IDE interface connector of the computer motherboard.

9. The dual flash disk storage device of claim 8, wherein the first flash disk storage device includes a first control unit and at least one first storage unit.

10. The dual flash disk storage device of claim 9, wherein the first storage unit is a flash memory.

11. The dual flash disk storage device of claim 8, wherein the second flash disk device includes a second control unit and at least one second storage unit.

12. The dual flash disk storage device of claim 11, wherein the second storage unit is a flash memory.

13. The dual flash disk storage device of claim 8, wherein the circuit board includes a jumper for setting the two flash disk storage devices separately to a master or a slave.
